(19) United States
(12) Patent Application Publication
(10) Pub. No.: US 2014/0096256 A1
(43) Pub. Date: Apr. 3, 2014

(54) JOINT PERFORMANCE-VULNERABILITY METRIC FRAMEWORK FOR DESIGNING AD HOC ROUTING PROTOCOLS

(71) Applicant: University of Washington through its Center for Co, (US)

(72) Inventors: Andrew Clark, Bellevue, WA (US); Radha Poovendran, Seattle, WA (US); Rommie L. Hardy, Adelphi, MD (US)

(73) Assignee: University of Washington through its Center for Commercialization, Seattle, WA (US)

(21) Appl. No.: 13/665,795

(22) Filed: Oct. 31, 2012

Related U.S. Application Data
(60) Provisional application No. 61/554,412, filed on Nov. 1, 2011.

(51) Int. Cl. H04L 29/06

(52) U.S. Cl. CPC H04L 63/1433
USPC 726/25

(57) ABSTRACT

A system for routing data along a path that is both efficient and secure is provided. A performance and vulnerability routing system selects a path for routing using a joint metric for a link in a network of nodes. The system calculates the joint metric based on a combination of a performance metric and a vulnerability metric of a link. The performance metric for a link indicates the cost of transmitting data over the link, and the vulnerability metric for the link indicates the security of data that is transmitted over the link. The system combines the performance metric and the vulnerability metric to generate the joint metric, which indicates a joint cost of transmitting data. The system then selects paths for transmitting data that tend to minimize the sum of the joint costs of the links along the paths.

### CROSS-REFERENCE TO RELATED APPLICATION

This application claims the benefit of U.S. Provisional Patent Application No. 61/554,412, entitled JOINT PERFORMANCE-VULNERABILITY ROUTING METRIC, filed Nov. 1, 2011, which is hereby incorporated by reference in its entirety.

### STATEMENT REGARDING FEDERALLY SPONSORED RESEARCH

This invention was made with government support under No. W911NF-07-1-0287 and No. W911NF-07-D-0001 through the Army Research Laboratory. The government has certain rights in the invention.

### BACKGROUND

In a wireless ad hoc network, a routing system may route message traffic between nodes of the network through multiple intermediate links (or hops) along a path. A routing system may use an ad hoc routing protocol that selects paths (or routes) that make efficient use of network resources. Ad hoc routing protocols include Optimal Link-State Routing, Dynamic Source Routing, and Ad hoc On-demand Distance Vector Routing. To evaluate the efficiency of a path, a routing system may consider the delay incurred by transmitting data over a link of the path, the energy cost of transmitting data over a link of the path, the effect on network throughput of transmitting data over a link of a path, and so on.

When a network is deployed in a hostile environment, a routing system that uses a multi-link routing protocol is susceptible to various types of attacks by an adversary. The routing protocol itself may be exploited in an attack. For example, an adversary in control of several network nodes may spread false information about the network topology during route selection. This false information may result in paths that are inefficient or pass through adversarial nodes, potentially leading to eavesdropping or packet loss. Ad hoc routing protocols may use authentication checks to prevent unauthorized nodes from interfering with route selection. However, even if the routing protocol is executed properly, each intermediate link creates a potential point of adversarial attack. For example, the adversary can carry out a denial-of-service attack by jamming an intermediate link. If messages are decrypted and re-encrypted at each hop, then recovery of the encryption key used by an intermediate link, either through cryptanalysis or physical capture, would allow the adversary to eavesdrop on a communication session. Many lightweight key management protocols use the same keys to secure different links. Unfortunately, the use of the same key for different links increases vulnerability to key compromise, because once an adversary captures a single key (e.g., through node capture), the adversary can eavesdrop on all the links that use that captured key.

In a heterogeneous network, different intermediate links will have varying levels of resilience to attack. Because of the different levels of resiliency, the most efficient path in terms of resource usage may also be highly vulnerable to attack. It would be desirable to have a routing system that factors in the vulnerability of the links to attack to select paths that are highly efficient in terms of resource usage and have a low vulnerability to attack.

### BRIEF DESCRIPTION OF THE DRAWINGS

FIG. 1A illustrates links between nodes of a network that are within communication range.

FIG. 1B illustrates nodes of the network that share a common encryption key.

FIG. 1C illustrates nodes in the network that are both within communication range and share a common encryption key.

FIG. 2 is a flow diagram that illustrates processing of a component of the PV routing system that calculates a joint PV metric in some embodiments.

### DETAILED DESCRIPTION

A method and system for routing data along a path that is both efficient and secure is provided. In some embodiments, a performance and vulnerability routing system (“PV routing system”) selects a path for routing using a joint performance vulnerability metric (“joint PV metric”) for a link in a network of nodes. The PV routing system calculates the joint PV metric based on a combination of a performance metric and a vulnerability metric of a link. The performance metric for a link indicates the cost of transmitting data over the link, and the vulnerability metric for the link indicates the security of data that is transmitted over the link. The PV routing system combines the performance metric and the vulnerability metric to generate the joint PV metric, which indicates a joint PV cost of transmitting data. The PV routing system then selects paths for transmitting data that tend to minimize the sum of the joint PV costs of the links along the paths.

The PV routing system may combine the performance metric and the vulnerability metric in various ways to generate the joint PV metric. For example, the PV routing system may add the performance metric and the vulnerability metric to generate the joint PV metric. As another example, the PV routing system may use the vulnerability metric as a threshold to determine whether to route over a link. If the vulnerability metric for a link is greater than a vulnerability threshold, then the PV routing system sets the joint PV metric to the performance metric. If, however, the vulnerability metric for the link is not greater than the vulnerability threshold, the PV routing system sets the joint metric to a value (e.g., the highest possible value) so that data is not transmitted over the link. The performance metric may be based on the expected number of transmissions involved in sending a packet of data over a link. For example, if a link is unreliable and many re-transmissions are needed, then the link has a high performance metric indicating that it is costly to transmit over that link. The PV routing system may base the performance metric on one or more cost characteristics that may include delay incurred by transmitting data over the link, energy cost of transmitting data over the link, and effect on network throughput of transmitting data over the link. The PV routing system may base the vulnerability metric on resilience of the link to the compromise of a key used to encrypt data that is transmitted over the link. For example, if a node that transmits data over a link is highly susceptible to capture, then the link may be given a high vulnerability metric. The resilience of a link may be based on expected time to have all keys that are used to encrypt data transmitted over the link compromised. In some embodiments, the PV routing system may also base the vulnerability metric on the risk that data being transmitted over the link will be compromised. Data transmitted over a link may be compromised in various ways such as by eavesdropping, denial of service, and route misdirection. A characteristic of the joint PV metric may be that its value decreases with a decreasing vulnerability metric and increases with an increasing performance metric. In some embodiments, the PV routing system may transmit data between a pair of nodes in a wireless network only when the nodes are within a transmission range and the nodes share an encryption key. The PV routing system may transmit data between the pair only when the vulnerability metric for the link between the nodes satisfies the vulnerability threshold.

The notation used in the following is defined in Table 1. The PV routing system may consider a network of N nodes to be indexed by the set V={1, . . . , N}. The nodes may be deployed over an area A ⊂ R² with node i at position xᵢ ∈ A. The PV routing system assumes that two nodes are capable of communicating over a direct wireless channel if they are within radio range r. Based on this assumption, the network has a range graph structure G_{g}=(V,E_{g}), where for any i, j ∈ V, (i, j)∈ E_{g} if and only if ∥xᵢ-xⱼ∥₂≦r.

TABLE 1

| Notation | Definition |
|---|---|
| V | Set of network nodes |
| N | Number of nodes |
| A | Network deployment region |
| xᵢ | Location of node with index i |
| r | Node radio range |
| G_{g} | Geometric network graph |
| K | Key pool |
| f | Key distribution function |
| P(K) | Set of subsets of K |
| P | Key pool size |
| m | Number of keys held by each node |
| Kᵢ | Set of keys held by node i |
| Gₖ | Key graph, defining set of nodes that share keys |
| G | Combined geometric/key graph, defining set of nodes |
| | capable of secure communication |
| S | Vulnerability metric |
| L | Cost metric |
| g | Joint performance-vulnerability metric |
| ETX | Expected number of packet transmissions |
| τ | Vulnerability threshold |

Due to the computational overhead associated with public key cryptography, the PV routing system may assume that nodes communicate with secret keys drawn from a key pool K according to a key distribution function ƒ:V→P(K), where P(K) is the set of subsets of K. Two nodes i, j ∈ V are capable of communicating securely only if they share at least one cryptographic key, i.e., if ƒ(i)∩ƒ(j)≠0. This induces a key graph structure Gₖ=(V,Eₖ), where (i, j) ∈ Eₖ if and only if ƒ(i)∩ƒ(j)≠0. The intersection of these two graph structures provides the set of nodes that are capable of secure communication. The network is considered to have the graph structure G=(V,E), where E=Eₖ∩E_{g}.

The PV routing system assumes an adversary that is active, mobile, and resource-constrained. An active adversary is capable of both passive eavesdropping and physically capturing nodes. Once a node is captured, the adversary gains access to its secret keys. As time progresses, the network may perform updates by adding new nodes, revoking compromised keys, and updating nodes with new keys. The PV routing system may assume that, due to resource constraints, the adversary cannot compromise a large subset of the network between updates. The adversary's mobility may enable it to monitor links throughout the network and gain knowledge of the network and routing topologies. This, combined with knowledge of the network protocols used, may allow the adversary to eavesdrop on any communication that is unencrypted or encrypted using compromised keys.

The PV routing system employs a metric that can be used to jointly evaluate vulnerability and performance of a given link. The end-to-end performance-security characteristics of a path can be described as the sum of the link metric values, allowing the use of standard shortest-path routing protocols.

The following definitions may be used to define the various metrics.
Definition 1: A function L:E→R_{≧0} is a link performance or cost metric if, for some cost criteria and two links l,l′∈ E, then L(l)≧L(l′) if and only if l has a higher cost than l′.
Definition 2: A function S:E→R_{≧0} is a link vulnerability metric if, for some security criteria and two links l,l′∈ E, then S(l)≧S(l′) if and only if l has higher security than l′.
Definition 3: A function g:E→R_{≧0} is a joint performance-vulnerability metric with respect to a link performance metric L and a link vulnerability metric S if and only if, for any links l,l′∈ E, then L(l)≧L(l′) and S(l)≧S(l′) implies that g(l)≧g (l′).

The PV routing system may base the performance metric on the delay incurred by using a link, the energy cost of making a transmission, or the effect of using a link on network throughput. Definition 3 states that a joint PV metric is well defined if its value decreases with decreasing vulnerability and increases with increased cost. Based on this definition, paths with the shortest length according to a joint PV metric will have minimal cost and a high security value. In the following, the joint PV metric is defined in terms of cost and vulnerability link metrics.
Definition 4: A routing protocol is said to be a resilience-enhanced routing protocol with respect to a joint performance-security metric g if the routes produced by the protocol are the shortest paths with respect to g. That is, for any nodes i, j ∈ V, a path π=(i=i₀, i₁, . . . , iₖ=j) generated by the protocol satisfies

$${\sum }_{l = 1}^{k} g ( ( {i}_{l - 1} , {i}_{l} ) ) \leq {\sum }_{l = 1}^{{k}^{′}} g ( ( {i}_{l - 1}^{′} , {i}_{l}^{′} ) )$$

for any path π′=(i=i₀′, i₁′, . . . , i_{k′}′=j).

Because the PV routing system bases the criteria for optimality on shortest paths, the joint PV metric can be integrated into existing routing protocols. By the definition of the joint PV metric, links with lower joint PV metric values will have higher security and lower cost.
Definition 5: Let G=(V,E) be the network graph structure. Let S be a vulnerability metric and let L be a cost metric. Then the joint PV metric g: E→R_{≧0} is given by

$$g ( l ) = \{ \begin{matrix}L ( l ) , & S ( l ) > r \\ ∞ , & else\end{matrix}$$

This definition is a threshold metric because links with a vulnerability metric exceeding a certain threshold are considered by the routing protocol, while links below the threshold are given infinite cost weight and may be ignored. This requires minimal extra computation compared to performance metrics alone. This threshold metric is based on the rationale that, since compromise of a single link will lead to the capture of all traffic passing through that link, the overall security of a path will be governed by the security of its weakest link. Guaranteeing a certain security level for a path is therefore equivalent to placing a lower bound on the security of the weakest link.

Two link performance metrics that are commonly used by existing routing protocols are hop count and link quality. Hop count is equal to the number of intermediate links in a path and is therefore equivalent to the length of a path when each link has a uniform weight of 1. In a wireless network where channel characteristics vary between links, hop count may not be an appropriate metric, since messages sent over lossy links will need to be retransmitted, leading to high resource cost in spite of low hop count. The ETX metric, the expected number of transmissions involved in sending a packet, may be used to provide an appropriate metric in the presence of lossy links. The ETX metric for link (A, B) is given by 1/(p_{A}*p_{B}), where p_{A} is the packet delivery probability for the A→B link and p_{B} is the packet delivery probability for the B→A link. These probabilities can be estimated by the nodes forming the link through the use of periodic probe packets.

In some embodiments, the PV routing system uses a vulnerability metric that is based on the resilience of a link to key compromise. During a node capture attack, keys that appear with great frequency in the network are captured first by an adversary. The frequency of key reuse is a function of the key distribution scheme used. Hence, the security of a link will depend both on the number of keys used and the number of times that each key is reused by the network.
Definition 6: Let l=(i, j) be a communication link. Let ƒ:V→P(K) be a key distribution mapping, and let Kᵢ:=ƒ(i) and Kᵢⱼ=Kᵢ ∩Kⱼ. Let X₁, X₂, . . . , Xₗ, . . . be integers selected uniformly at random from V, and let Cₛ=∪ₗ₌₁^{s}K_{X}_{ₗ}. The random variable Tₖ is the min {s:k ∈ Cₛ} and Tᵢⱼ is the max {Tₖ:k ∈Kᵢⱼ}. The metric S(l) is given by E(Tᵢⱼ).
   Intuitively, this metric can be stated in the following way. If nodes from the network are drawn or captured at random, the keys recovered from each captured node, and the captured node is replaced or returned to the network. The keys recovered from each node are added to a pool of recovered keys. The metric is the expected time to gather all keys securing the link. T represents the time to recover key K, and Tᵢⱼ represents the time to recover all keys shared by nodes i and j.

The joint PV metric may be defined as follows:

$$g ( l ) = \{ \begin{matrix}ETX ( l ) , & S ( l ) > r \\ ∞ , & else\end{matrix}$$

In some embodiments of the PV routing system, each node of a pair computes the vulnerability metric for the link between them. If the vulnerability metric does not exceed a specified vulnerability threshold, the nodes do not form any connections. Otherwise, they proceed as in a conventional routing protocol. Because the performance of the routing depends on the vulnerability threshold, a network owner can set the threshold to achieve desired performance and security characteristics.

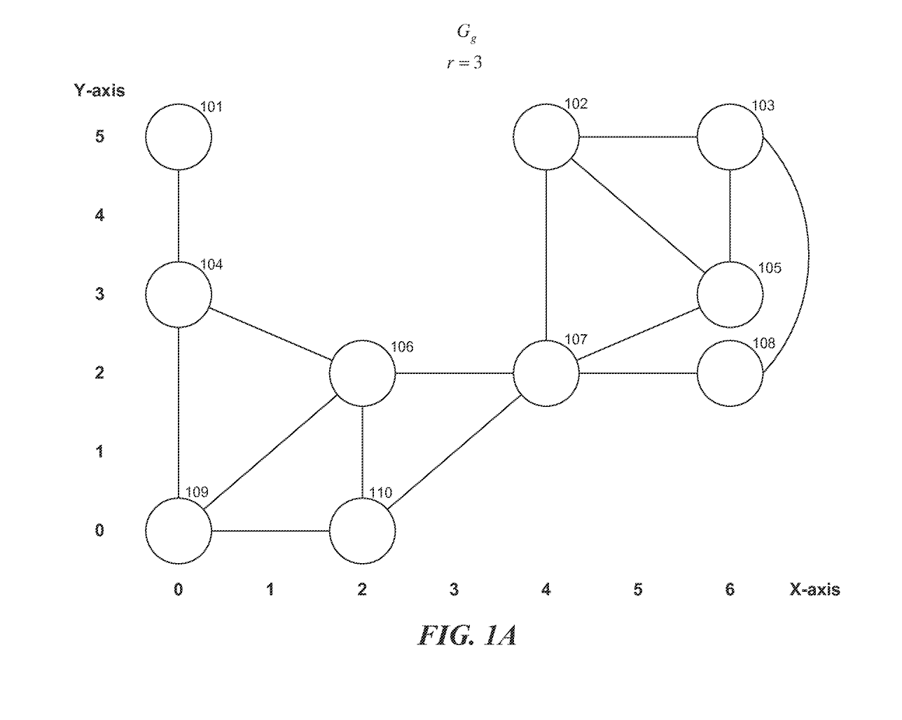

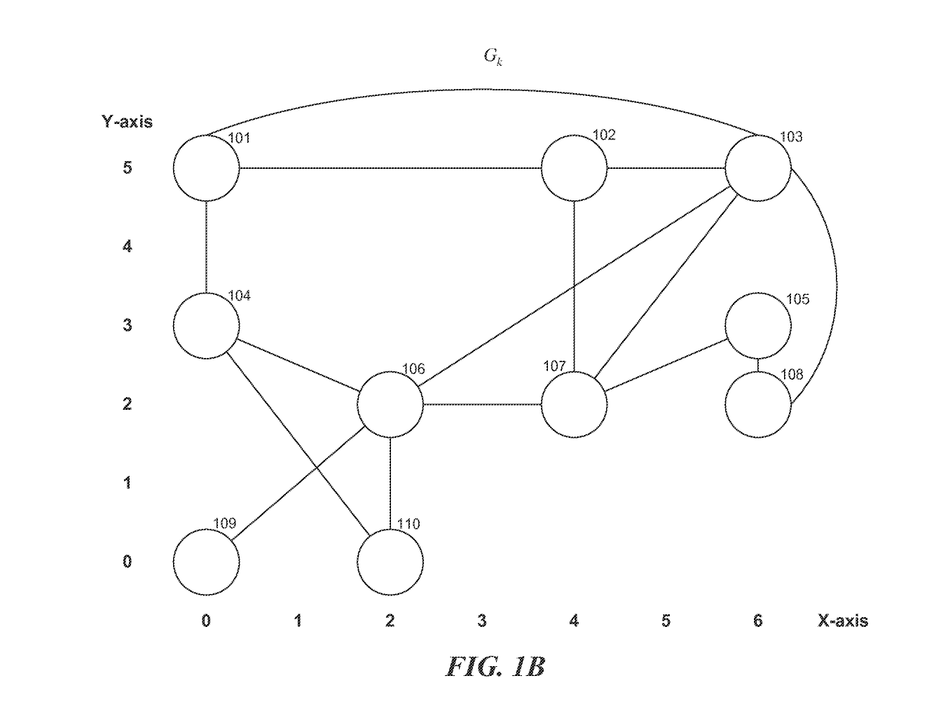

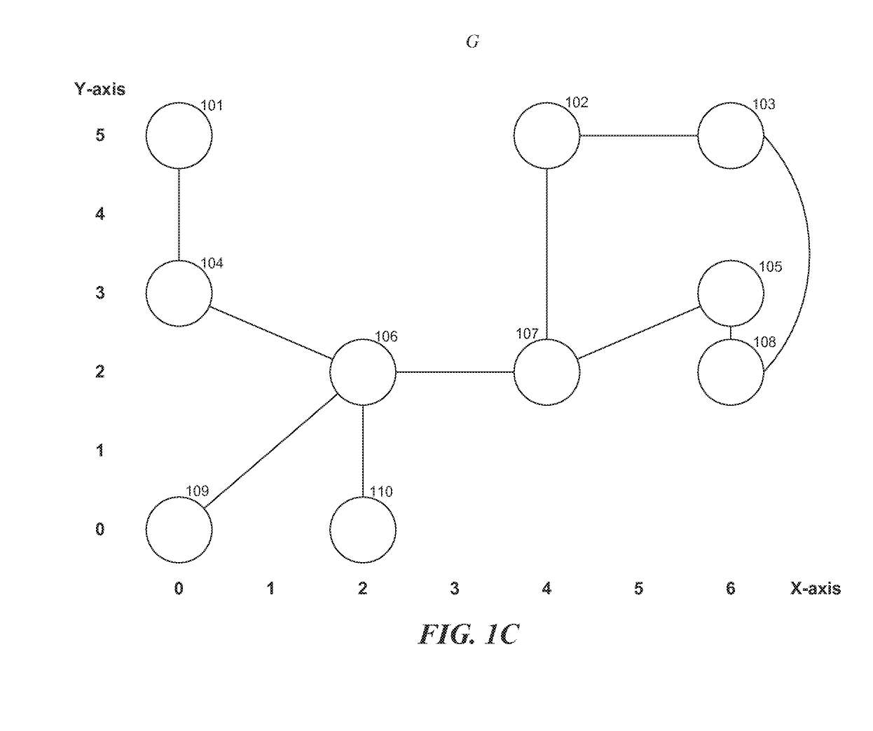

FIG. 1A illustrates links between nodes of a network that are within communication range. The network includes nodes 101-110 that are located within a grid that has an x-axis and a y-axis. The location of each node is given by its grid coordinates. For example, node 109 is at location (0,0), node 110 is at location (2,0), and node 103 is at location (6,5). The lines between the nodes represent communication links that are within range assuming that the communication range is a distance of 3. For example, the line between node 104 and node 109 indicates that the distance between the nodes is within the communication range. As a result, node 104 and node 109 are permitted to establish a connection. As another example, the absence of a line between node 104 and node 110 indicates that the distance between the nodes is not within the communication range. As a result, node 104 and node 110 are not permitted to establish a connection.

FIG. 1B illustrates nodes of the network that share a common encryption key. The lines between the nodes represent that the nodes share a common encryption key. For example, the line between node 104 and node 110 indicates that the nodes have at least one key in common. As a result, the nodes have the potential to transmit encrypted data to each other. However, since node 104 and node 110 are not within communication range, no connection can be formed between node 104 and node 110 and thus encrypted data cannot be sent between node 104 and node 110. As another example, the absence of a line between node 104 and node 109 indicates that the nodes do not share a common key. As a result, the nodes cannot be used to transmit encrypted data even though they are within communication range.

FIG. 1C illustrates nodes in the network that are both within communication range and share a common encryption key. The lines between the nodes represent that the nodes are with range and share a common key. Thus, the lines represent the links that can be used to transmit data. The lines of FIG. 1C represent the intersection of the lines of FIGS. 1A and 1B. For example, since node 104 and node 106 have a line between them in FIGS. 1A and 1B, the nodes have a line between them in FIG. 1C. As a result, node 104 and node 106 can transmit data to each other. As another example, since node 104 and node 109 do not have a line between them in FIG. 1B (i.e., do not share a key), even though they have a line between them in FIG. 1A (i.e., are within range), the nodes have no line between them in FIG. 1C. As a result, node 104 and node 109 cannot transmit data to each other.

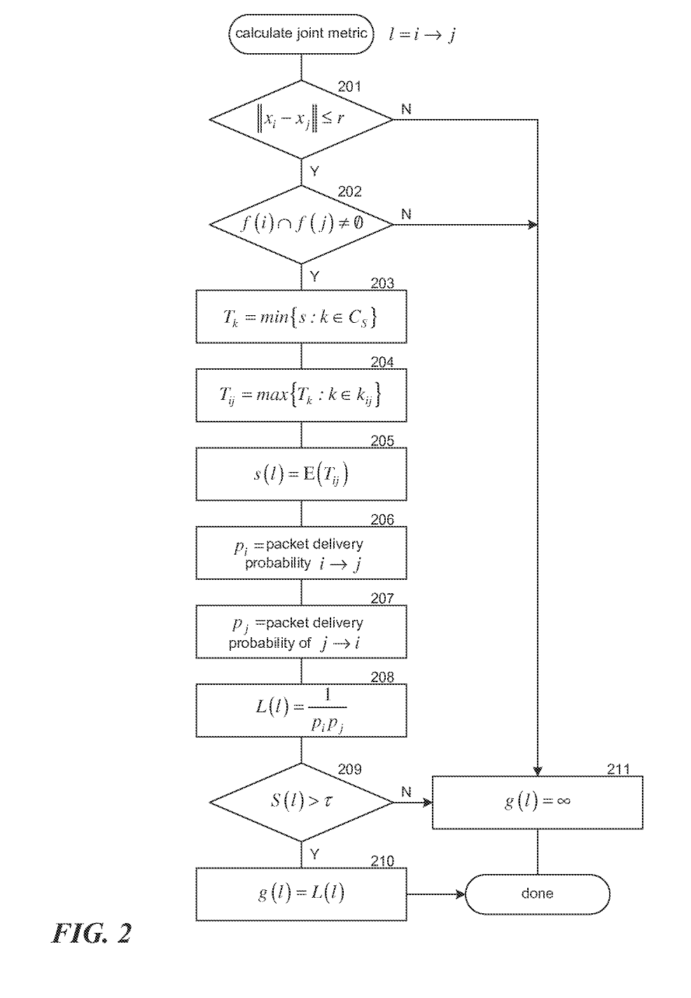

FIG. 2 is a flow diagram that illustrates processing of a component of the PV routing system that calculates a joint PV metric in some embodiments. The component is provided with an identification of a pair of nodes and calculates the joint PV metric for that pair of nodes. The component checks whether the nodes are within communication range and share an encryption key. If not, the component sets the joint PV metric to a value indicating that data cannot be transmitted between the nodes. The component also indicates that data cannot be transmitted between the nodes when the vulnerability metric does not meet a vulnerability threshold. Otherwise, the component sets the joint PV metric to the performance metric. In decision block 201, if the nodes are within range, the component continues at block 202, else the component continues at block 211. In decision block 202, if the nodes share a key, the component continues at block 203, else the component continues at block 211. In bock 203, the component defines the random variable Tₖ. In block 204, the component defines the random variable Tᵢⱼ. In block 205, the component sets the vulnerability metric S(l) to the expected time for all keys shared by the nodes to be compromised. In blocks 206 and 207, the component sets the packet delivery probability for transmitted data between the nodes in each direction. In block 208, the component sets the performance metric L(l) to ETX(l). In decision block 209, if the vulnerability metric is greater than the vulnerability threshold, then the component continues at block 210, else the component continues at block 211. In block 210, the component sets the joint PV metric to the performance metric and then completes. In block 211, the component sets the joint PV metric to a value that indicates that data is not to be transmitted between the nodes and then completes.

The processor on which the PV routing system may be implemented may include a central processing unit and local memory and may include input devices (e.g., keyboards and pointing devices), output devices (e.g., display devices), and storage devices (e.g., disk drives). The processors may access computer-readable media that includes computer-readable storage media and data transmission media. The computer-readable storage media includes memory and other storage devices that may have recorded upon or may be encoded with computer-executable instructions or logic that implements the PV routing system. The data transmission media is media for transmitting data using signals or carrier waves (e.g., electromagnetism) via a wire or wireless connection. Various functions of the PV routing system may also be implemented on devices using discrete logic or logic embedded as an application-specific integrated circuit. The nodes and other devices on which the PV routing system may be implemented are computing devices.

The PV routing system may be described in the general context of computer-executable instructions, such as program modules, executed by one or more computers, processors, or other devices. Generally, program modules include routines, programs, objects, components, data structures, and so on, that perform particular tasks or implement particular data types. Typically, the functionality of the program modules may be combined or distributed as desired in various embodiments.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method for generating a joint metric for a link in a network of nodes, the joint metric based on a performance characteristic and a vulnerability characteristic of the link, the method comprising:
generating the performance metric for the link indicating cost of transmitting data over the link;
generating the vulnerability metric for the link indicating security of data that is transmitted over the link; and
combining the performance metric and the vulnerability metric to generate the joint metric.

2. The method of claim 1 wherein the combining to generate the joint metric includes:
determining whether the vulnerability metric is greater than a threshold;
after determining that the vulnerability metric is greater than the threshold, setting the joint metric to the performance metric; and
after determining that the vulnerability metric is not greater than the threshold, setting the joint metric to a value so that data is not transmitted over the link.

3. The method of claim 1 wherein the performance metric is based on an expected number of transmissions involved in sending a packet of data.

4. The method of claim 1 wherein the performance metric is based on a cost characteristic that is selected from a group consisting of delay incurred by transmitting data over the link, energy cost of transmitting data over the link, and effect on network throughput of transmitting data over the link.

5. The method of claim 1 wherein the vulnerability metric is based on resilience of the link to having a key, which is used to encrypt data transmitted over the link, be compromised.

6. The method of claim 5 wherein the resilience is based on an expected time to have all keys that are used to encrypt data transmitted over the link be compromised.

7. The method of claim 1 wherein the vulnerability metric is based on risk that data being transmitted over the link will be compromised.

8. The method of claim 7 wherein the data is compromised by an action selected from a group consisting of eavesdropping, denial of service, and route misdirection.

9. The method of claim 1 wherein the joint metric decreases with decreasing vulnerability of the link and increases with increased cost of the link.

10. The method of claim 1 wherein the generating of the joint metric is performed by a node that transmits over the link.

11. A node in a communication network for transmitting data to and receiving data from other nodes in the communication network via links between the nodes, the node comprising:
a component that generates a performance metric for the link indicating cost of transmitting data over the link;
a component that generates a vulnerability metric for the link indicating security of data that is transmitted over the link;
a component that combines the performance metric and the vulnerability metric to generate the joint metric; and
a component that transmits data over a link when the joint metric indicates that the link is selected for transmission based on cost and security of transmitting over the link.

12. The node of claim 11 wherein the links are wireless links and wherein a pair of nodes transmit data to each other only when the nodes are within communication range and the nodes share an encryption key.

13. The node of claim 12 wherein the pair of nodes transmit data to each other only if the vulnerability metric for the link between the nodes satisfies a threshold.

14. The node of claim 13 wherein the joint metric is set to the performance metric.

15. The node of claim 11 wherein the vulnerability metric is based on key exposure and flow exposure.

16. The node of claim 11 wherein the performance metric is based on a criterion selected from a group consisting of energy consumption, delay, and hop count.

17. The node of claim 11 wherein a routing path from a first node to a second node is a lowest cost path based on minimizing a sum of the joint metrics for links in the path.

18. An article of manufacture storing instructions for generating a joint metric for a link in a network of nodes, the instructions specifying operations comprising:
generating a performance metric for a link indicating cost of transmitting data over the link;
generating a vulnerability metric for the link indicating security of data that is transmitted over the link; and
combining the performance metric and the vulnerability metric to generate the joint metric.

19. The article of manufacture of claim 18 wherein the links are wireless links and wherein a pair of nodes transmit data to each other only when the nodes are within a transmission range and the nodes share an encryption key.

20. The article of manufacture of claim 19 wherein the pair of nodes transmit data to each other only when the vulnerability metric for the link between the nodes satisfies a vulnerability metric and wherein the joint metric is set to the performance metric.
